(19) United States
(12) Patent Application Publication
(10) Pub. No.: US 2011/0187750 A1
(43) Pub. Date: Aug. 4, 2011

(54) APPARATUS FOR CONTROLLING AN IMAGE AND METHOD

(75) Inventors: Woo Suk KO, Seoul (KR); Suk-Hyen JUNG, Seoul (KR); Sungwoo HAN, Seoul (KR); Choong Woon PARK, Bucheon-si (KR); Nakyung LIM, Seoul (KR); Yong Hwan KIM, Seoul (KR); Hyunsoo KIM, Yongin-si (KR); Woo Young LEE, Seoul (KR)

(73) Assignee: PANTECH CO., LTD., Seoul (KR)

(21) Appl. No.: 12/907,790

(22) Filed: Oct. 19, 2010

(30) Foreign Application Priority Data
Feb. 3, 2010 (KR) 10-2010-0009795

(51) Int. Cl. G09G 5/00

(52) U.S. Cl. 345/661

(57) ABSTRACT

A method for controlling an image may include activating a selected area of the image based on a touch point, setting the selected area according to a maintained touch input or according to a second input, increasing a zoom of the image, and outputting the zoomed selected area if a touch release is sensed. An apparatus to control an image displayed on a screen may include a touch sensing unit, a display unit, and a screen processing unit of which the screen processing unit activates a selected area and zooms the selected area based on a touch.

### CROSS-REFERENCE TO RELATED APPLICATION

This application claims priority from and the benefit of Korean Patent Application No. 10-2010-0009795, filed on Feb. 3, 2010, which is hereby incorporated by reference for all purposes as if fully set forth herein.

### BACKGROUND

1. Field

This disclosure relates to an apparatus to control an image displayed on a screen and a method therefor.

2. Discussion of the Background

In general, a touch screen is an input/output device that receives input data from a screen if a hand or an input device, such as a stylus and the like, touches the touch screen. The touch screen may determine a touch location at which the input device is touched and perform a specific process corresponding to the touch. The touch screen may also include a display device to display information. The touch screen is a relatively new input device to replace a conventional input device, such as a mouse, a keyboard, and the like. When the touch screen is applied to a display device of a portable terminal, a conventional keypad may be omitted, and thus, a display area thereof may increase.

A variety of touch screen input methods for increasing/decreasing a zoom of a conventional screen have been developed. An increase/decrease slider may be separately arranged, and an increase/decrease in the zoom may be performed using the slider arranged in a predetermined area of the screen. A degree of the increase/decrease may be proportional to a degree of movement of the increase/decrease slider. Also, the increase/decrease may be performed by combining an input via the keypad and an input via the touch screen. However, the above described methods may increase a size of the screen based on a center of the screen as opposed to based on a desired location, and thus, the user may have to adjust the screen to the desired location after the increase in the zoom is performed.

As another method, the increase/decrease in the zoom is performed by using a multi-touch screen. The method may perform the increase/decrease in the zoom of the image, and a degree of the increase/decrease may be proportional to a variation in a distance between points of the multi-touch input via the multi-touch. Although the method of using the multi-touch screen may increase the zoom of the screen based on the desired location, a cost is large compared with a single-input touch screen.

### SUMMARY

Exemplary embodiments of the present invention provide a method for controlling an image and apparatus to control an image displayed on a screen.

Exemplary embodiments of the present invention provide a method and apparatus that controls an image displayed on a screen based on a desired location using a touch screen input.

Exemplary embodiments of the present invention also provide a method and apparatus that increases a zoom of an image at a location by a magnification using a single touch input on a touch screen.

Exemplary embodiments of the present invention also provide a method and apparatus that receives a center location, sets a size of a selected area, and increases a zoom of the set selected area, and outputs the zoomed, set selected area to a screen.

Additional features of the invention will be set forth in the description which follows, and in part will be apparent from the description, or may be learned by practice of the invention.

An exemplary embodiment of the present invention discloses a method for controlling an image, the method including displaying the image on a screen; activating a selected area of the image based on a touch point if a touch is sensed; adjusting a size of the selected area if the touch is maintained; setting the size of the selected area, increasing a zoom of the selected area; and displaying the zoomed selected area on the screen if a touch release is sensed.

An exemplary embodiment of the present invention discloses a method for controlling an image, the method including displaying the image on a screen; activating a selected area of the image based on a touch point if a touch is sensed; receiving a setting input to adjust a size of the selected area; increasing a zoom of the selected area; and displaying the zoomed selected area in the screen.

An exemplary embodiment of the present invention discloses an apparatus to control an image displayed on a screen, the apparatus including a touch sensing unit to sense a touch on the screen; a display unit to display the image on the screen; a screen processing unit to activate a selected area based on a touch point of the touch, to adjust a size of the selected area if the touch is maintained, and to set the size of the selected area and increase a zoom of the selected area to output the zoomed selected area to the display unit.

An exemplary embodiment of the present invention discloses an apparatus to control an image displayed on a screen, the apparatus including a touch sensing unit to sense a touch on the screen; a display unit to display the image on the screen; a screen processing unit to activate a selected area based on a touch point of the touch, to receive a setting input to adjust a size of the selected area, and to set the size of the selected area and increase a zoom of the set selected area to output the zoomed selected area to the display unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of an apparatus to control an image according to an exemplary embodiment of the present invention.

FIG. 2 is a diagram illustrating an increase of a zoom of a selected area according to an exemplary embodiment of the present invention.

FIG. 3 is a diagram illustrating an activation of a selected area according to an exemplary embodiment of the present invention.

FIG. 4 is a diagram illustrating an activation of a selected area according to an exemplary embodiment of the present invention.

FIG. 5 is a diagram illustrating a change in a size of a selected area according to an exemplary embodiment of the present invention.

FIG. 6 is a diagram illustrating a movement of a selected area according to an exemplary embodiment.

FIG. 7 is a diagram illustrating a method for adjusting a size of a selected area according to an exemplary embodiment of the present invention.

FIG. 8 is a diagram illustrating a method for adjusting a size of a selected area according to an exemplary embodiment of the present invention.

FIG. 9 is a flowchart illustrating a method for controlling an image according to an exemplary embodiment.

FIG. 10 is a flowchart illustrating a method for controlling an image according to an exemplary embodiment of the present invention.

FIG. 11 is a flowchart illustrating a method for controlling an image according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element is referred to as being “directly connected to” another element or layer, there are no intervening elements present.

According to an exemplary embodiment of the present invention, a screen controlling method and apparatus controls, using an input on a touch screen, a magnification of a screen at a desired location.

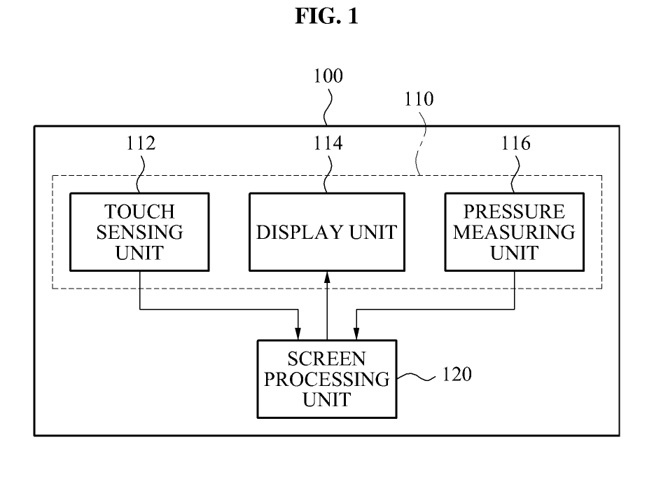

FIG. 1 illustrates a configuration of a apparatus 100 to control an image according to an exemplary embodiment of the present invention. Referring to FIG. 1, the screen controlling apparatus 100 may include a touch screen 110 and a screen processing unit 120. In this instance, the touch screen 110 may include a touch sensing unit 112, a display unit 114, and a pressure measuring unit 116.

The touch sensing unit 112 may be mounted on the display unit 114, and may include a touch panel or a touch sensor. Also, the touch sensing unit 112 may sense, using the touch panel or the touch sensor, a touch or a touch movement generated by a user. The touch sensor 112 may generate an input signal corresponding to the sensed touch and may transmit the generated input signal to the screen processing unit 120. If a touch occurs, the touch sensing unit 112 may detect a change sensed in a physical quantity, for example, a capacitance or a resistance and the like, may convert the detected change into an electric signal, and may transmit the electric signal to the screen processing unit 120.

The display unit 114 may display an image outputted from the screen processing unit 120. The display unit 114 may be at least one of a Liquid Crystal Display (LCD), or an organic or inorganic Light Emitting Diode (LED) display, and the like.

The pressure measuring unit 116 may measure a pressure of a touch at a touch point.

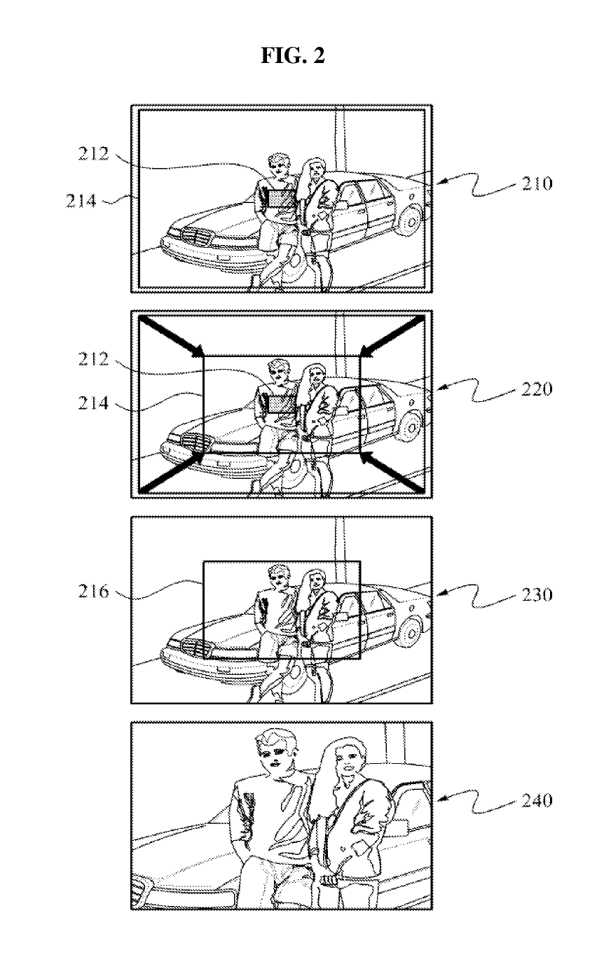

If the touch is sensed, the screen processing unit 120 may activate a selected area based on the touch point, may set the selected area if the touch is maintained, and may increase the set selected area to a full screen to output the increased selected area to the display unit 114 if a touch release is sensed. An operation of the screen processing unit 120 will be described with reference to FIG. 2.

FIG. 2 illustrates an increase of a zoom of a selected area according to an exemplary embodiment of the present invention. Referring to FIG. 2, if a touch is sensed in a touch area 212, the screen processing unit 120 activates a selected area 214 based on a touch area 212 in operation 210, sets the selected area 214 if the touch is maintained in operation 220, and, if the touch is released in operation 230, sets the current selected area 214 as a set selected area 216, and increases the zoom of the displayed screen to the set selected area 216. The set selected area 216 may be zoomed to be displayed as a full screen image or may be zoomed to display the set selected area 216 in an entirety of an image output area, i.e., less than a full screen, of the display unit 114 in operation 240.

The screen processing unit 120 may display the selected area 214 distinctively from the non-selected area when the selected area 214 is activated. To distinctively display the selected area 214 from the non-selected area, the selected area 214 may be displayed with an outline, as shown in FIG. 2, or one of the selected area 214 and the non-selected area may be displayed by a shadow or a watermark.

If a size of an output image is less than or equal to a size of the full screen, the screen processing unit 120 may change the set selected area 216 to a size equal to a size of the output image. Also, if the size of the output image is greater than the size of the full screen, the screen processing unit 120 may change the set selected area 216 to a size equal to a size of the full screen.

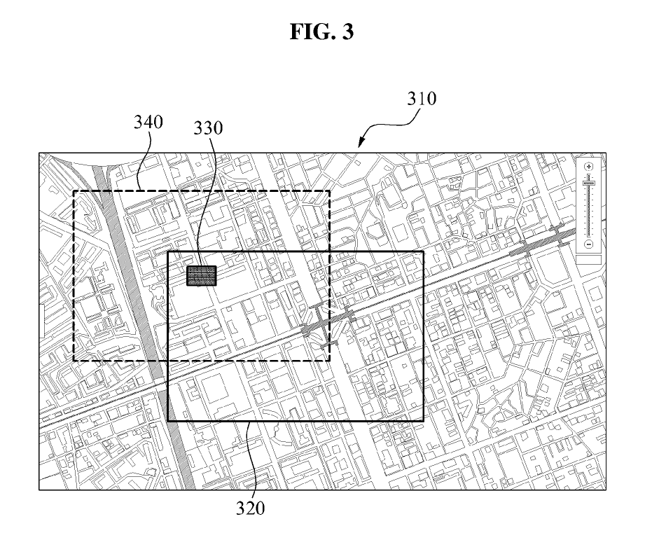

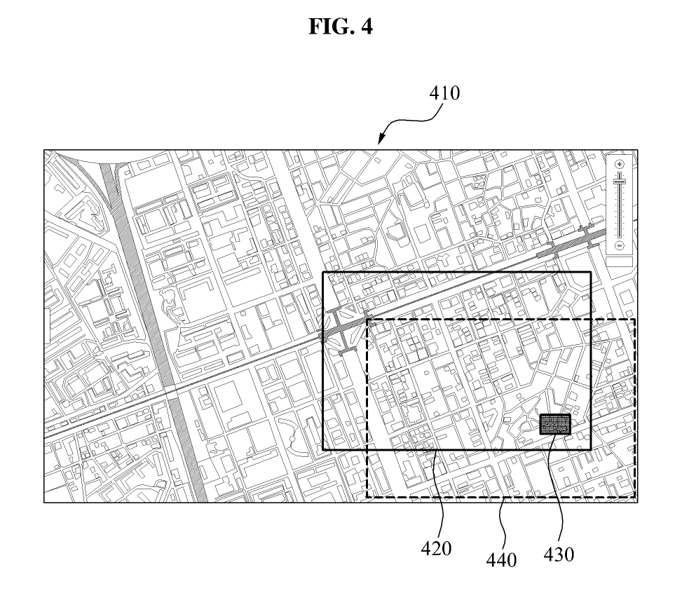

If the size of output image is greater than the size of the full screen, the screen processing unit 120 may activate a selected area to locate a touch point at a center of the selected area as illustrated in FIGS. 3 and 4.

FIG. 3 illustrates an activation of a selected area according to an exemplary embodiment of the present invention. Referring to FIG. 3, a size of an image 310 is greater than a size of a full screen 320 and a selected area 340 is generated to locate a touch point 330 at a center of the selected area 340. If the entire selected area 340 exists in the image 310, the screen processing unit 120 may activate the selected area 340 to locate the touch point 330 at a center of the selected area 340.

FIG. 4 illustrates an activation of a selected area according to an exemplary embodiment of the present invention. Referring to FIG. 4, a size of an image 410 is greater than a full screen 420 and a selected area 440 is generated to locate a touch point 430 at a center of the selected area 440 if the selected area is activated. If the selected area 440 does not completely exist in the image 410, the screen processing unit 120 may activate the selected area 440 to locate the touch point 430 at the center of the selected area 440 or as near the center of the selected area 440 that completely exists within the image 410.

The screen processing unit 120 may increase or decrease a zoom of the selected area 440 based on the touch point 430 if a touch is maintained at the touch point 430 for an amount of time.

The screen processing unit 120 may gradually increase or gradually decrease a size of a selected area between a minimum size and a size of a full screen if a touch is maintained on a touch point 430 for an amount of time.

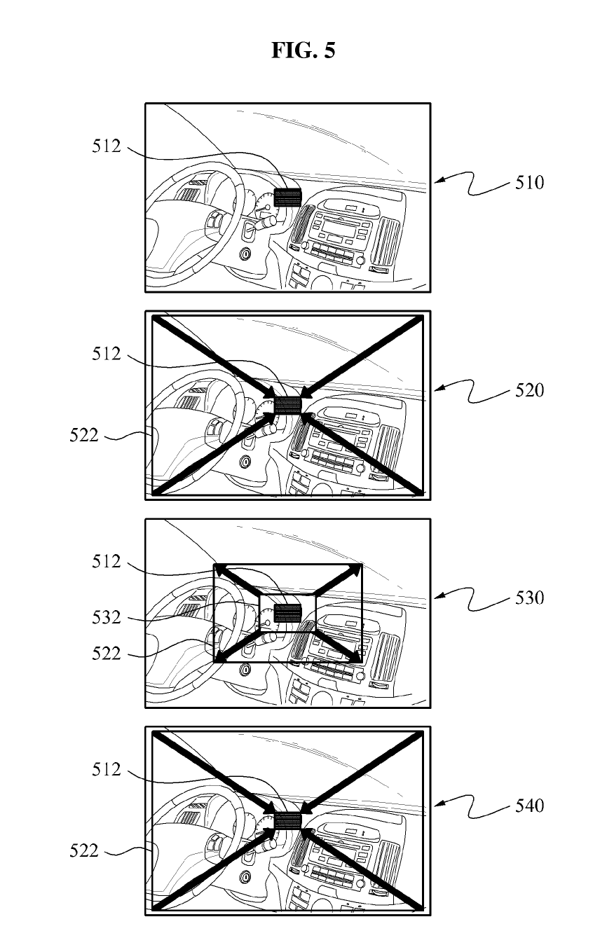

FIG. 5 illustrates a change in a size of a selected area according to an exemplary embodiment of the present invention. Referring to FIG. 5, if a touch point 512 is input in operation 510, and a touch at the touch point 512 is maintained, the screen processing unit 120 gradually decreases a size of a selected area 522 in operation 520. If the selected area 522 is decreased to a minimum size 532, and the touch is maintained, the screen processing unit 120 may gradually increase the size the selected area 522 in operation 530. Also, if the selected area 522 is increased to a size of a full screen, and the touch is maintained, the screen processing unit 120 may gradually decrease the selected area 522 in operation 540.

The screen processing unit 120 may set the amount of time for changing the size of the selected area 522 based on a pressure measured by the pressure measuring unit 116. The screen processing unit 120 may adjust a speed of increasing or decreasing the size of the selected area 522 using a pressure measured by the pressure measuring unit 116. As an example, the screen processing unit 120 may determine the amount of time to be relatively short when the pressure is strong, thereby increasing the speed of increasing or decreasing the size of the selected area. Conversely, the screen processing unit 120 may determine the amount of time to be relatively long when the pressure is weak, thereby decreasing the speed of increasing or decreasing the size of the selected area.

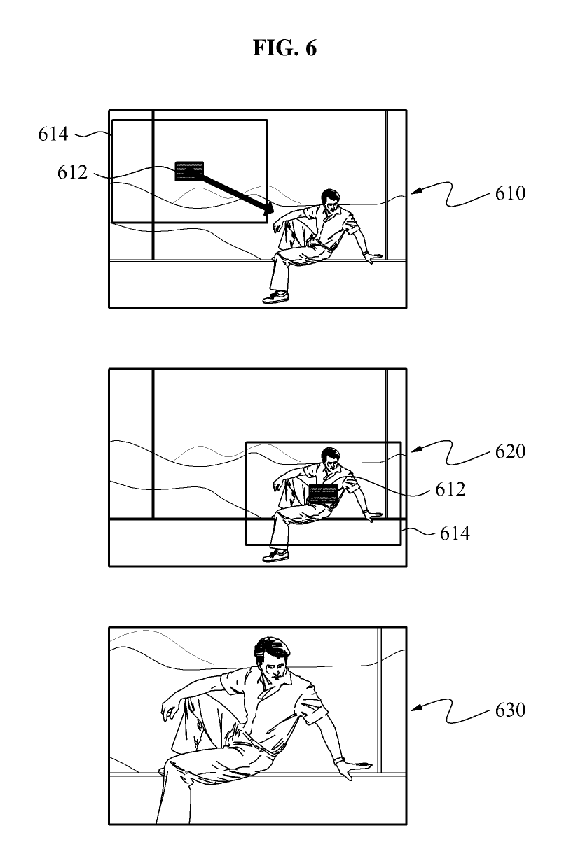

The screen processing unit 120 may move a selected area based on a touch point as illustrated in FIG. 6 if the touch point is moved using a drag to set the selected area.

FIG. 6 illustrates a movement of a selected area according to an exemplary embodiment. Referring to FIG. 6, if a movement of a touch point 612 is sensed, i.e., a drag is input, in operation 610, the screen processing unit 120 may output the touch point 612 at a point where the drag is finished in operation 620, and may output a selected area 614 to locate the touch point 612 at a center of the selected area 614. Also, if a touch release of the touch point 612 is sensed, the screen processing unit 120 may increase a zoom of the selected area 614 and output the moved selected area 614 in operation 630.

When a flicking input is sensed, the screen processing unit 120 may cancel an activation of the selected area, and may convert the selected area into a previous state of the activation.

According to the above descriptions, the screen processing unit 120 increases a zoom of a screen at a desired location by a desired magnification with a single touch. The screen processing unit 120 may also increase the screen at a desired location by the desired magnification with at least two touches. Hereinafter, the screen processing unit 120 that controls a screen with at least two touches will be described.

If a first touch is sensed, the screen processing unit 120 may activate a selected area based on a first touch point, may receive a setting input, namely, a second touch, to set the selected area, may increase a zoom of the set selected area, and may output the increased selected area to the display unit 114.

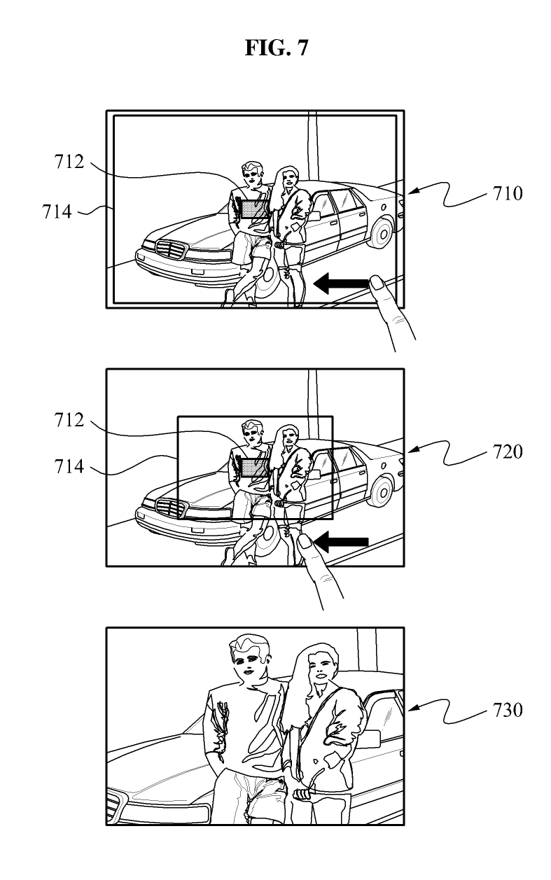

If a drag toward a first touch point is sensed as a setting input for setting a selected area as illustrated in FIG. 7, the screen processing unit 120 may decrease a size of the selected area to be proportional to a dragged distance.

FIG. 7 illustrates a method for adjusting a size of a selected area according to an exemplary embodiment of the present invention. Referring to FIG. 7, the screen processing unit 120 may output a touch point 712 and may activate a selected area 714 in operation 710. If a drag in a direction of an arrow is sensed in operation 720, the screen processing unit 120 may decrease a size of the selected area 714 to be proportional to a dragged distance. Also, the screen processing unit 120 may increase a zoom of the selected are 714 and output the selected area 714 in a full screen in operation 730. The selected area 714 need not be displayed as a full screen image but may be increased in zoom to correspond to an entirety of an image output area of a display of the display unit 114.

If a drag dragged away from the touch point is sensed as the setting input, the screen processing unit 120 may increase the size of the selected area 714 to be proportional to a dragged distance.

As another method of receiving at least two touches, if a first touch is sensed, the screen processing unit 120 may activate a selected area based on a first touch point, and may horizontally or vertically output, on a screen, a magnification scrollbar for adjusting a magnification of the image. Subsequently, if a movement of a scroll of the magnification scrollbar, namely, a second touch, is input, the screen processing unit 120 may adjust the size of the selected area based on an amount of scroll of the magnification scrollbar to set the selected area, and may increase the selected area to a full screen to output the increased selected area to the display unit 114.

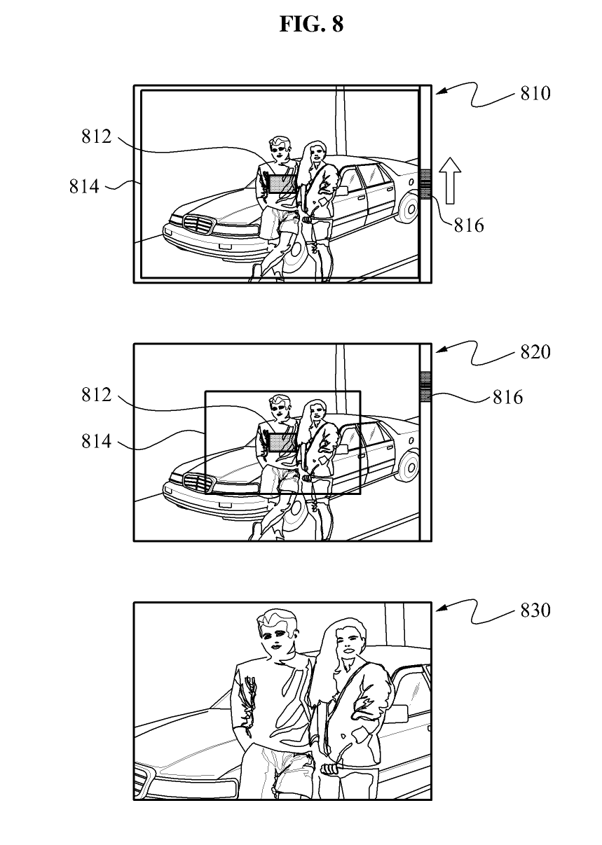

FIG. 8 illustrates a method for adjusting a size of a selected area according to an exemplary embodiment of the present invention. Referring to FIG. 8, the screen processing unit 120 may output a touch point 812 and a magnification scrollbar 816 and may activate a selected area 814 in operation 810. Also, if a scroll of the magnification scrollbar 816 is sensed in a direction of an arrow, the screen processing unit 120 may decrease a size of the selected area 814 to be proportional to a scrolled distance of the magnification scrollbar 816 in operation 820. Also, the screen processing unit 120 may increase a zoom of the selected area 814 and output the selected area 814 to a full screen in operation 830. The selected area 814 need not be displayed as a full screen image but may be increased in zoom to correspond to an entirety of an image output area of a display of the display unit 114.

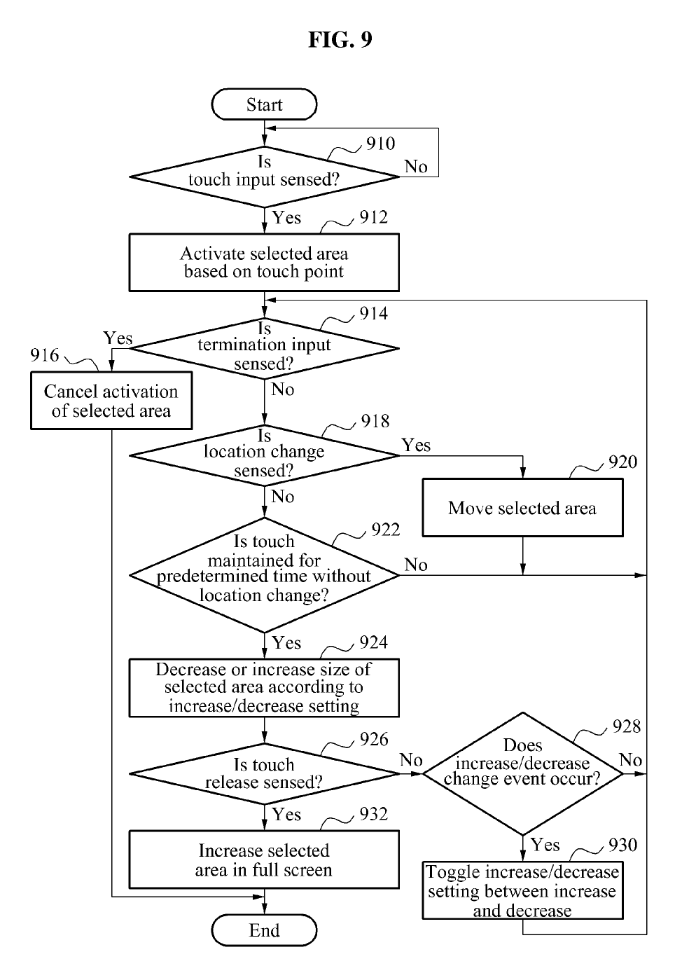

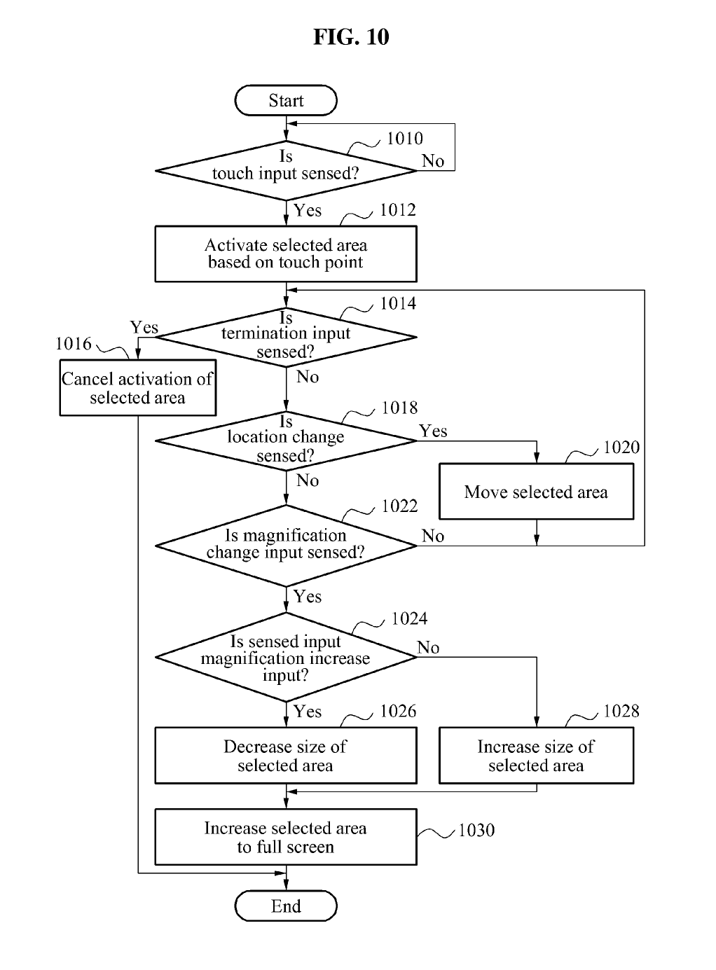

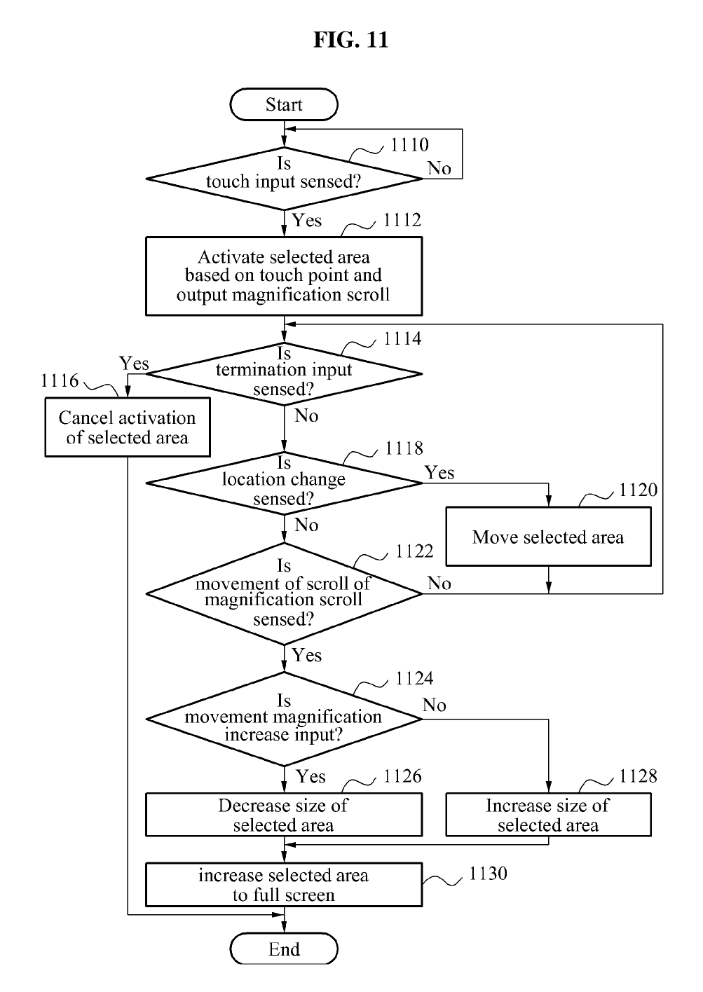

Hereinafter, methods for controlling a screen using a touch screen input will be described in detail with reference to FIG. 9, FIG. 10, and FIG. 11.

FIG. 9 illustrates a method for controlling an image according to an exemplary embodiment. Referring to FIG. 9, if a touch input is sensed in operation 910, a screen controlling apparatus activates a selected area based on a touch point in operation 912.

If a termination input is sensed in operation 914, the screen controlling apparatus cancels the activation of the selected area, and converts the selected area into a previous state in operation 916. In this instance, the termination input may be a flicking input. Further, the termination input may be a flicking input on the touch point.

The touch point may be moved using a drag. If a location change of the touch point is sensed in operation 918, the screen controlling apparatus moves the selected area based on the touch point in operation 920.

Also, if it is sensed that a touch is maintained for an amount of time without changing a location in operation 922, the screen controlling apparatus may increase or decrease a size of the selected area based on the touch point according to an increase/decrease setting in operation 924.

If the touch release is not sensed in operation 926, the screen controlling apparatus proceeds to operation 928. If an increase/decrease change event is sensed in operation 928, the screen controlling apparatus may toggle the increase/decrease setting between an increase and a decrease in operation 930 and repeat back to operation 914.

The screen controlling apparatus determines whether a touch release is sensed, and if the touch release is not sensed in operation 926, the screen controlling apparatus repeatedly performs operation 914 through operation 930 until the touch release is sensed at operation 926.

If the touch release is sensed in operation 926, the screen controlling apparatus may increase a zoom of the selected area and output the zoomed selected area in a full screen. Aspects are not limited thereto such that the zoomed selected area need not be displayed in a full screen and may be displayed as an entirety of an image output area of a screen of a display.

FIG. 10 illustrates a method for controlling an image according to an exemplary embodiment of the present invention. Referring to FIG. 10, the screen controlling apparatus activates a selected area based on a touch point in operation 1012 if a first touch input is sensed in operation 1010.

If a termination input is sensed in operation 1014, the screen controlling apparatus cancels the activation of the selected area and converts the selected area into a previous state in operation 1016. In this instance, the termination input may be a flicking input. Further, the termination input may be a flicking input on the touch point.

The touch point may be moved by using a drag. If a location change of the touch point is sensed in operation 1018, the screen controlling apparatus may move the selected area based on the touch point in operation 1020.

If a magnification change input is sensed in operation 1022, the screen controlling apparatus may determine whether the sensed input is a magnification increase input or a magnification decrease input in operation 1024.

If the determining of operation 1024 determines that the sensed input is the magnification increase input, for example, the sensed input is a drag toward the touch point, the screen controlling apparatus may decrease the selected area to be proportional to a dragged distance in operation 1026.

If the determining of operation 1024 determines that the sensed input is the magnification decrease input, for example, the sensed input is a drag dragged away from the touch point, the screen controlling apparatus may increase the selected area to be proportional to the dragged distance in operation 1028.

Subsequently, the screen controlling apparatus may increase and output the selected area in a full screen in operation 1030. Aspects are not limited thereto such that the selected area need not be displayed in a full screen and may be displayed as an entirety of an image output area of a screen of a display.

FIG. 11 illustrates a method for controlling an image according to an exemplary embodiment of the present invention. Referring to FIG. 11, if a first touch input is sensed in operation 1110, the screen controlling apparatus activates a selected area based on a touch point, and outputs a magnification scrollbar in operation 1112.

If a termination input is sensed in operation 1114, the screen controlling apparatus cancels the activation of the selected area and converts the selected area into a previous state of the activation in operation 1116. In this instance, the termination input may be a flicking input. Further, the termination input may be a flicking input on the touch point.

The touch point may be moved by using a drag. If a location change of the touch point is sensed in operation 1118, the screen controlling apparatus moves the selected area based on the touch point in operation 1120.

If a movement of a scroll of a magnification scrollbar is sensed in operation 1122, the screen controlling apparatus determines whether the sensed movement of the scrollbar is a magnification increase input in operation 1124.

If the determining of operation 1124 determines that the sensed movement of the scrollbar is the magnification increase input, the screen controlling apparatus decreases the selected area to be proportional to a scrolled distance in operation 1126.

If the determining of operation 1124 determines that the sensed movement of the scrollbar is a magnification decrease input, the screen controlling apparatus increases the selected area to be proportional to the scrolled distance in operation 1128.

Subsequently, the screen controlling apparatus increases and outputs the selected area in a full screen in operation 1130. Aspects are not limited thereto such that the selected area need not be displayed in a full screen and may be displayed as an entirety of an image output area of a screen of a display.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media, such as hard disks, floppy disks, and magnetic tape; optical media, such as CD ROM disks and DVD; magneto-optical media, such as optical disks; and hardware devices that are specially configured to store and perform program instructions, such as read-only memory (ROM), random access memory (RAM), flash memory, and the like, and combinations thereof. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling an image, the method comprising:
displaying the image on a screen;
activating a selected area of the image based on a touch point if a touch is sensed;
adjusting a size of the selected area if the touch is maintained; and
setting the size of the selected area, increasing a zoom of the selected area; and displaying the zoomed selected area on the screen if a touch release is sensed.

2. The method of claim 1, wherein the activating comprises:
displaying the touch point on the screen and displaying the selected area to be distinguished from an unselected area of the image.

3. The method of claim 1, wherein the activating comprises:
activating the selected area to have a size equal to a size of the image if the size of the image is less than or equal to a size of the screen; and
activating the selected area to have a size equal to the size of the screen, if the size of the image is greater than the size of the screen.

4. The method of claim 1, wherein the activating comprises:
activating the selected area to locate the touch point at a center of the selected area if a size of the image is greater than a size of the full screen.

5. The method of claim 1, wherein the setting comprises:
decreasing a size of the selected area based on the touch point if the touch is maintained on the touch point for an amount of time.

6. The method of claim 1, wherein the setting comprises:
increasing a size of the selected area based on the touch point if the touch is maintained on the touch point for an amount of time.

7. The method of claim 1, wherein the setting comprises:
gradually increasing or gradually decreasing a size of the selected area between a minimum size and a size of the screen if the touch is maintained on the touch point for an amount of time.

8. The method of claim 7, wherein the setting comprises:
measuring a pressure at the touch point and setting the amount of time based on the measured pressure.

9. The method of claim 1, wherein the setting comprises:
moving the selected area based on the touch point if the touch point is moved using a drag.

10. The method of claim 1, further comprising:
canceling the activation of the selected area and converting the selected area into a previous state if a flicking input is sensed.

11. A method for controlling an image, the method comprising:
displaying the image on a screen;
activating a selected area of the image based on a touch point if a touch is sensed;
receiving a setting input to adjust a size of the selected area; and
setting the size of the selected area, increasing a zoom of the selected area; and displaying the zoomed selected area in the screen.

12. The method of claim 11, further comprising: decreasing a size of the selected area in proportion to a dragged distance if the setting input comprises a drag toward the touch point.

13. The method of claim 11, further comprising: increasing a size of the selected area in proportion to a dragged distance if the setting input comprises a drag away from the touch point.

14. The method of claim 11, further comprising:
displaying a magnification scrollbar for adjusting a magnification of the image based on the touch point,
wherein a size of the selected area is based on an amount of scroll of the magnification scrollbar.

15. An apparatus to control an image displayed on a screen, the apparatus comprising:
a touch sensing unit to sense a touch of the screen;
a display unit to display the image on the screen;
a screen processing unit to activate a selected area based on a touch point of the touch, to adjust a size of the selected area if the touch is maintained, and to set the size of the selected area and increase a zoom of the selected area to output the zoomed, selected area to the display unit.

16. The apparatus of claim 15, wherein the screen processing unit activates the selected area by displaying the touch point on the screen and displaying the selected area to be distinguished from an unselected area of the image.

17. The apparatus of claim 15, wherein the screen processing unit activates the selected area to a size equal to a size of the image if the size of the image is less than or equal to a size of the screen, and activates the selected area to a size equal to the size of the screen if the size of the image is greater than the size of the screen.

18. The apparatus of claim 15, wherein the screen processing unit activates the selected area to locate the touch point at a center of the selected area if a size of the image is greater than a size of the screen.

19. The apparatus of claim 15, wherein the screen processing unit decreases a size of the selected area based on the touch point if the touch is maintained on the touch point for an amount of time.

20. The apparatus of claim 15, wherein the screen processing unit increases a size of the selected area based on the touch point if the touch is maintained on the touch point for an amount of time.

21. The apparatus of claim 15, wherein the screen processing unit gradually increases or gradually decreases a size of the selected area between a minimum size and a size of the screen if the touch is maintained on the touch point for an amount of time.

22. The apparatus of claim 21, further comprising a pressure measuring unit to measure a pressure of the touch at the touch point,
wherein the screen processing unit sets the amount of time based on the measured pressure.

23. The apparatus of claim 15, wherein the screen processing unit moves the selected area based on the touch point if the touch point is moved using a drag.

24. The apparatus of claim 15, wherein the screen processing unit cancels the activation of the selected area and converts the selected area into a previous state if a flicking input is sensed on the screen.

25. An apparatus to control an image displayed on a screen, the apparatus comprising:
a touch sensing unit to sense a touch on the screen;
a display unit to display the image on the screen;
a screen processing unit to activate a selected area based on a touch point of the touch, to receive a setting input to adjust a size of the selected area, and to set the size of the selected area and increase a zoom of the selected area to output the zoomed selected area to the display unit.

26. The apparatus of claim 25, wherein, if the setting input comprises a drag toward the touch point, the screen processing unit decreases a size of the selected area in proportion to a dragged distance of the drag.

27. The apparatus of claim 25, wherein, if the setting input comprises a drag dragged away from the touch point, the screen processing unit increases the size of the selected area in proportion to a dragged distance of the drag.

28. The apparatus of claim 25, wherein the screen processing unit outputs on the screen a magnification scrollbar to adjust a magnification of the image, and adjusts a size of the selected area based on an amount of scroll of the magnification scrollbar.
